(19) United States
(12) Patent Application Publication
(10) Pub. No.: US 2023/0348122 A1
(43) Pub. Date: Nov. 2, 2023

(54) SYSTEMS AND METHODS FOR MANAGING LOADS OR MANNED OR UNMANNED VEHICLES

(71) Applicant: AIRROW, INC., Encino, CA (US)

(72) Inventors: Menachem Mendel Fehler, Encino, CA (US); David Nochum Kaye, Los Angeles, CA (US); Aaron Keit, Woodland Hills, CA (US)

(21) Appl. No.: 18/130,745

(22) Filed: Apr. 4, 2023

Related U.S. Application Data
(60) Provisional application No. 63/346,719, filed on May 27, 2022.
(60) Provisional application No. 63/344,986, filed on May 23, 2022.
(60) Provisional application No. 63/327,315, filed on Apr. 4, 2022.

(51) Int. Cl. B64U 80/25; B64U 50/39

(52) U.S. Cl. CPC B64U 80/25; B64U 50/39; B64U 2101/64

(57) ABSTRACT

A robotic arm configured to load and unload one or more payloads from a drone, the robotic arm comprising: a central body portion; one or more arm sections configured to rotate with respect to the central body portion; one or more end effectors attached to respective end portions of the one or more arm sections; one or more unlocking mechanisms configured to unlock the one or more payloads from the drone; and at least one mechanism configured to remove the one or more payloads from the drone.

### RELATED APPLICATIONS

This application claims priority under 35 U.S.C. §119(e) to U.S. Provisional Pat. Application Nos. 63/327,315, filed Apr. 4, 2022, entitled “Systems and Methods for a Platform for Swapping Out Various Payloads,” 63/344,986, filed May 23, 2022, entitled “Systems and Methods for a Payload Case for Swapping Out Various Payloads To and From a Vehicle,” and 63/346,719, filed May 27, 2022, entitled “Systems and Methods for a Robotic Arm for Swapping Out Various Payloads To and From a Vehicle,” each of which is incorporated herein by reference as if set forth in full.

### BACKGROUND

### Field

The embodiments described herein are generally directed to the autonomous or semi-autonomous swapping of payloads, e.g., batteries or other payloads, being transported by some form of vehicle, including autonomous or semi-autonomous vehicles, and more particularly, to systems and methods for rapid and efficient swapping of such payloads carried by autonomous vehicles such as drones.

### Description of the Related Art

Autonomous vehicles, e.g., unmanned systems or vehicles, such as drones offer tremendous value in industries such as agriculture, security, inspection, law enforcement, the military, mining, oil and gas, construction, surveyance, delivery and many others. Other examples of unmanned systems, which may be semi or fully autonomous or may be remote controlled, include unmanned aerial vehicles (UAVs), unmanned ground vehicles (UGVs) and unmanned surface vehicles (USVs), unmanned underwater vehicles (UUV) and other “Unmanned systems” (UMS). Most commercial drones have a very limited flight time, e.g., around 30 mins. The primary limitation is limited battery power. Consequently, longer flights or repetitive use of such, e.g., drones requires that the batteries be swapped out.

A complicating factor for the efficient, automated swapping of drone batteries is the battery connection. As noted in U.S. Pat. Publication No. 2020/0324013 (the ‘013 Publication), which is incorporated herein by reference in its entirety as if set forth in full, one limitation of vehicles that carry their own energy source, i.e., battery is that they will necessarily exhaust that supply of energy, through travel or other use. An example of this issue is in drones which are commonly powered by batteries. When the store of electrical energy in a battery of a drone is nearly depleted it is necessary to land the drone (if it is airborne) and replace or recharge the battery. Accordingly, the useful range of drones from their starting location is limited by the quantity of electrical energy which they are able to carry with them.

In recent years, drones have found increasingly common usage, for example in such fields as delivery and surveillance. As the range of activities to which drones are employed has increased the useful flying range of drones has become a significant limiting factor in their further utilization. Moreover, when operating a large fleet of drones the need to replace batteries on each drone after each flight becomes an onerous and time consuming task. Such replacement of depleted batteries in drones is typically accomplished by hand. This replacement increases the downtime of the drone between flights, thereby increasing the overall cost of drone operation. Moreover, replacement of batteries by hand carries the cost of employment of personnel for carrying out the replacement.

Meanwhile, there are numerous sizes, shapes and types of electric batteries currently on the market and in use in drones (and in other vehicles). Each drone is commonly adapted for use with only a specific size, shape and type of battery. Accordingly, only specific batteries are able to be used with specific drones. Therefore, when replacing a battery in a drone a specific type of battery must be selected for that replacement. If the requisite battery is not available then replacement cannot be affected and the drone will have to remain idle, even if other batteries having different sizes, shapes or types are available for use in a charged condition; however, using a common rail system and locking mechanism for the batteries can enable one drone to hold and utilize different size batteries that share the same connection and rail but have a different e.g. capacity, discharge rates and overall storage of electricity.

It should also be noted that there may be other aspects related to the unmanned vehicle that need to be loaded/unloaded, replaced, filled, attached, etc. For example, a drone may have a package or object that needs to be loaded or unloaded, there may be other matter to be loaded or unloaded such as powdered or liquid fertilizer into a spray tank associated with the unmanned vehicle, gas to fill a gas tank in a gas powered vehicle, addition of or swapping out of ammunition, sensors or components such as a camera or propeller. Again, at present, these are all manually assisted operations.

### SUMMARY

Accordingly, systems and methods are disclosed for a drone hub that provides for rapid and efficient swapping of drone batteries in a drone hub, and more particularly, for robotic arm(s) of a drone hub.

According to one aspect, a robotic arm configured to load and unload one or more payloads from a drone, the robotic arm comprising: a central body portion; one or more arm sections configured to rotate with respect to the central body portion; one or more end effectors attached to respective end portions of the one or more arm sections; one or more unlocking mechanisms configured to unlock the one or more payloads from the drone; and at least one mechanism configured to remove the one or more payloads from the drone.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the disclosed processes for rapid and efficient swapping of drone batteries in a drone hub can be implemented, according to an embodiment;

FIG. 2 illustrates an example processing system, by which one or more of the processes described herein, may be executed, according to an embodiment;

FIG. 3 illustrates an example drone hub, according to an example embodiment; FIG. 4 illustrates the process for swapping a battery/payload using the drone hub of FIG. 3 according to one example embodiment;

FIG. 5 illustrates an arm with grippers that can be used in the drone hub of FIG. 3, in accordance with one example embodiment;

FIGS. 6 and 7 illustrate the arm of FIG. 5 engaging a battery bay in accordance with an example embodiment;

FIGS. 8A-8C illustrate a rail that can be installed in a drone and configured to receive a battery or package encased in a housing in according with one example embodiment;

FIGS. 9A-9D illustrates a housing with a locking mechanism that can hold a battery or other payload and interface with the rail of FIGS. 8A-C in accordance with one example embodiment;

FIGS. 9E -9F illustrate another embodiment of a locking mechanism design that may be used with the housing of FIGS. 9A-D and the rail of FIGS. 8A-C;

FIGS. 10A-C illustrates a rail that can be included in a charging hub and configured to receive the housing of FIGS. 9A-9D in accordance with one example embodiment;

FIG. 11 illustrates an arm configuration that can be used in the drone hub of FIG. 3 in accordance with one example embodiment;

FIGS. 12A-12C illustrate drone hubs, according to various embodiments of the disclosure;

FIGS. 13A-13C illustrates an arm with upper and lower sections that can rotate such that the upper and lower section reverse positions in accordance with one embodiment;

FIGS. 14A and 14B illustrate a rail that can be installed in a drone or charging station and that includes a locking mechanism in accordance with one embodiment;

FIGS. 15A-15C illustrate another example of a rail with a locking mechanism that can hold larger payloads in accordance with one embodiment;

FIGS. 16A-16C illustrate a similar rail with a plate that can hold multiple payloads and can drop the packages with precision in accordance with one embodiment;

FIGS. 17A-17C illustrate another embodiment of a plate that acts as a dropping mechanism in accordance with one example embodiment;

FIG. 18 illustrates a drone hub with an alternative arm configuration in accordance with one embodiment;

FIG. 19 illustrates a drone hub with an alternative arm configuration in accordance with one embodiment;

FIGS. 20A-20B illustrates a drone hub with an alternative payload bay configuration in accordance with one embodiment;

FIGS. 21A-21B illustrates a drone hub with an alternative payload bay configuration in accordance with one embodiment;

FIGS. 22A-22C illustrates a drone hub with an alternative payload bay configuration in accordance with one embodiment;

FIGS. 23, 24, and 25 illustrates multi-drone embodiments in accordance with various embodiments;

FIG. 26A illustrates a drone hub with an alternative drone type, in accordance with another embodiment;

FIG. 26B illustrates an embodiment of a drone hub without a landing pad; and

FIGS. 27A-27C and 28 illustrate an alternative arm configuration in accordance with one embodiment.

### DETAILED DESCRIPTION

After reading this description, it will become apparent to one skilled in the art how to implement the claims in various alternative embodiments and alternative applications. However, although various embodiments are described herein, it is understood that these embodiments are presented by way of example and illustration only, and not limitation. As such, this detailed description of various embodiments should not be construed to limit the scope or breadth of the appended claims.

While many of the embodiments described herein are described in the context of what is referred to a drone hub, it should be noted that the systems and methods, such as the computer vision systems and methods can be applied to the loading and unloading, addition and replacement, filling and emptying, of packages, objects, matter, components, etc., and whether the vehicle is manned or unmanned. In other words, the vehicle or machine can be any type of machine, such as a regular or electrical vehicle, a plane, or some other machine. For example, the “hub” can be for electrical vehicles to pull up and automatically have the battery charged, or replaced, groceries put in the trunk, etc. Thus, it will be understood that the embodiments described herein are by way of example only and not intended to limit the scope of the claims that follow to a particular implementation, such as the described drone hub.

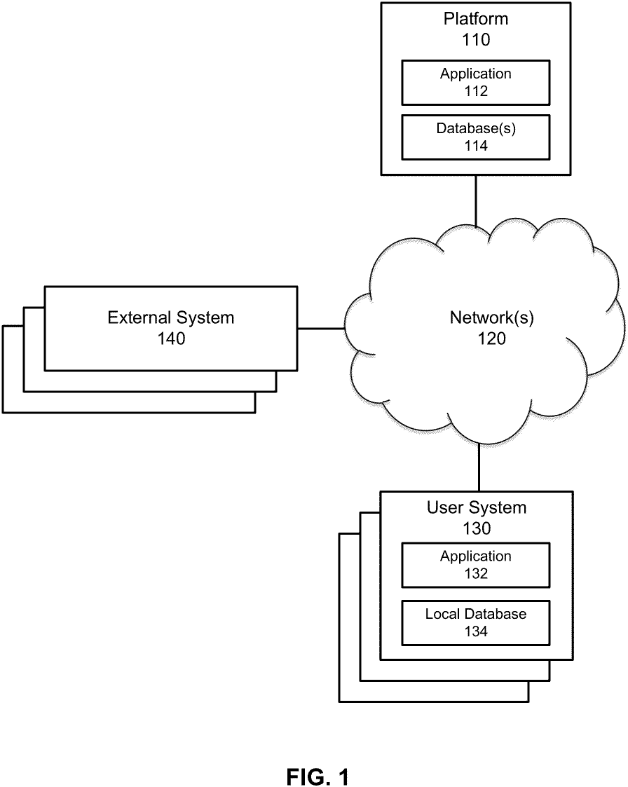

FIG. 1 illustrates an example infrastructure in which one or more of the disclosed processes for rapid and efficient swapping of drone batteries in a drone hub can be implemented, according to an embodiment. The infrastructure can comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions of the application described herein.

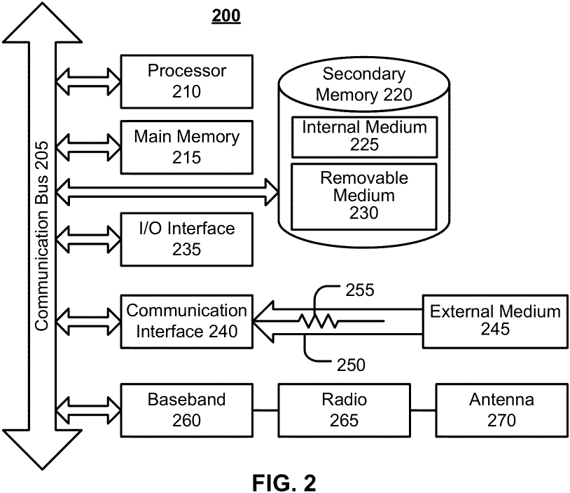

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for rapid and efficient swapping of drone batteries in a drone hub will now be described in detail. It should be understood that the described processes may be embodied in one or more software modules that are executed by one or more hardware processors (e.g., processor 110), for example, as a computer program or software package. The described processes may be implemented as instructions represented in source code, object code, and/or machine code. These instructions may be executed directly by hardware processor(s) 110, or alternatively, may be executed by a virtual machine operating between the object code and hardware processors 110.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

A drone hub as described herein is at its core, an autonomous drone station, designed to be capable of integrating with multiple drone manufacturers, with minimal design work, and modification to the drones that allows the drone to be back in operation within a matter of seconds. This allows for complete automation of the mission with minimal down time. If there are multiple drones, then by rotating the drones, the length of time the drones are active can be increased, e.g., to even 24/7 operation. As explained below, the drone hub described herein can also be used as a pitstop/gas station for extending the range, allowing refueling, rearming, reloading, repair, etc. of delivery drones or drones used for other purposes.

In addition, newer drones are being specifically designed to operate without a runway, through vertical takeoff and landing (VTOL). This allows drones to operate in very populous areas where real estate and space is at a premium, as the infrastructure to support VTOLs is almost just a landing space. Often rooftops have minimal usage, such as for air conditioners and in some cases solar. A drone hub the size of just 1 solar panel is a small rooftop real estate expense, and has a great value proposition for payload logistics and other drone uses in an urban environment.

The drone hub can be completely automated - meaning it supplies everything in a plug and play set up needed to operate the mission autonomously. This includes thebase or servicing area, battery storage bays, telemetry, power, capability to communicate with the drone such as send the drone missions or operate the drone hub and the drone from anywhere in the world, recharging, inventory management of batteries, environmental protection, etc. The drone hub described herein can be designed to be both stationary, and mobile. It is also extremely precise in its operations, raising the success rate of battery swaps, as well as durable, simple, relatively inexpensive to build and reliable.

Thus, a drone hub as described herein can be part of an infrastructure as described in FIG. 1, where the drone hub(s) can actually be a user system(s) 130, with processing system 200 controlling operations.

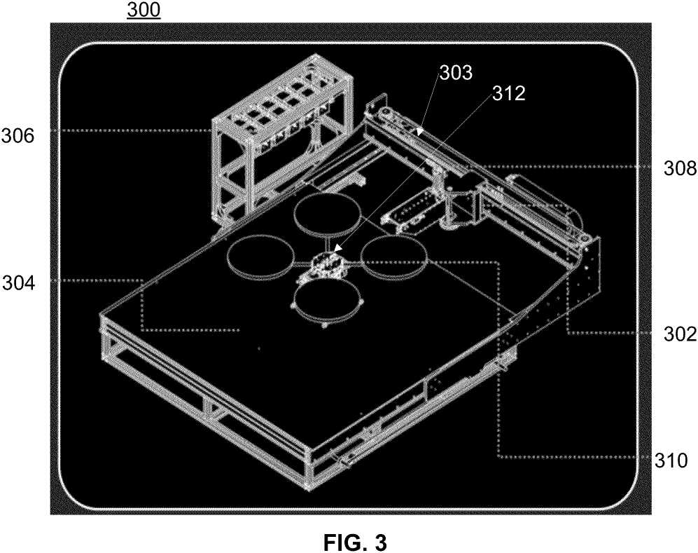

The main components from a hardware perspective of such a drone hub can include: robotic arm; end effector; Key, locking mechanism, and key motor; computer vision; LEDs; precision landing; Camera’s; weather sensors; battery charging station; Custom Battery storage compartment on the station; and on the drone; custom case for the battery. FIG. 3 illustrates an example drone hub 300 in accordance with one embodiment. Hub 300 can include a robotic arm 302, such as a 3 axis cartesian robotic arm with one axis being rotary. Certain other embodiments can include a 4^{th} axis, the Z-axis. The gantry style of robotic arm 302 provides low cost and high precision.

Some use cases benefit from a robotic arm with more axis, such as 5 or 6-axis, as it opens up more options for battery storage, payload storage, and battery removal locations, e.g., if a drone has a battery inserted from on top. In addition, the battery bays on conventional hubs are limited in their location to being on the sides of, in front, or behind the arms gantry. A 6 axis arm 302 as described herein enables the battery or payload bays to be stored behind, above and below the gantry or in other areas unreachable by, e.g., a 3 axis arm. Having the battery/payload bays under the base 304 allows a more compact design.

For 5 and 6 axis arms, the arm may be stationary. But in other embodiments, Hub 300 includes a rail or pulley system 303 on which arm 302 can travel back and forth. In certain embodiments, Teknic ClearPath motors controlled by, e.g., a Galil motor controller(s), which can be part of or interfaced with system 200, are used to control arm 302. In this example, a battery charging station 306 that can hold, e.g., 6-12 batteries, is positioned on the left of base 304. As noted above, if arm 302 is a 6-axis arm, then battery charging station or bay 306 can be underneath base 304. Moreover, in certain embodiments, the battery bay can be separate from the hub 300.

Base 304 can be large enough, e.g., 5 ft × 5 ft, such that it can hold 2 or more drones of, e.g., up to 2 ft × 2 ft.

Hub 300 can also include a camera 308 that is configured to detect the drone 310, and can guide and control arm 302, in conjunction with system 200.

Drone 310 comprises a battery bay 312 that can comprise a locking mechanism, e.g., as described in the ‘013 Publication. In this example, the camera 308 is positioned on arm 302 and in a position where the camera 308 can see the drone 310 and the drone battery bay 312.

Drone detection can be done via a combination of depth and optical sensors, e.g., camera 308. For example, the system can stream depth images from the camera 308 as a pointcloud. This pointcloud can then be filtered using a library and then sent to ROS for use by, e.g., the MoveIt package as an occupancy map for collision avoidance. The pointcloud can also be processed by, e.g., the PointCloud2 Library by filtering and performing correspondence grouping to detect objects on the stage. Correspondence groupings are compared for similarities to known objects (drones) and an approximate position and orientation is output.

All suspected drone objects can then be analyzed in an attempt to detect an interaction point, which is a point on the drone marked with a pattern. The pattern can for example be three Normalized Barcode Tags from the AprilTag library. The AprilTag library is used to search streaming color video from, e.g., the RealSense Camera 302 looking for preselected tags that are standalone or in a known pattern. The AprilTag library detects the known pattern of tags that represents the drone grip point and returns the position in 3D space relative to the drone hub 300. For precision and accuracy, multiple approach steps are taken and the detected positions can be averaged together before using the position to activate movement of arm 302.

Once arm 302 is in position to grip the drone grip point, the tag pattern position relative to the arm is again validated to within an allowed threshold before the grippers are activated to grip the drone. Once the drone is gripped, the position is again validated before any interaction is allowed with the battery. Upon the successful grip of the drone, the programmed camera offset is adjusted to account for minor variances in camera mounting position. After interaction with the drone is complete, the grippers release the drone and the arm backs off to a stored approach position.

The arm then moves to the battery storage area and uses, e.g., AprilTag detections to find the grip points of the available storage bays 306. A similar stepped approach is taken to the storage bays to ensure precise and accurate interaction with the grip points. After depositing the removed battery to an open bay, the approach process is started again and the arm moves to the pickup bay. For speed and accuracy, the charging bays can also have their positions hard coded, and can have vision used to confirm precise alignment as an extra redundancy before swapping.

Once the arm 302 has collected the replacement battery, the arm is moved back to an approach position, e.g., about 10 cm away from the drone 310. From there the, e.g., AprilTag detection is used again with a stepped approach to the drone grip points. Position and grip are both validated before inserting the charged battery into the waiting drone. After depositing the battery, the Drone hub arm returns to its home position and waits for the next drone to land, triggering another swap cycle. Alternatively, the swap cycle can be triggered by a software command from another authorized system such as a UTM, or flight operation software, or the drone itself

To help with the alignment and precision, certain embodiments include sensors on the end of the arm 302 to increase accuracy and redundancy. For example, adding two ToF sensors or micro linear actuators spaced, e.g., about 20 cm apart can provide great angle and distance measurements.

The compartment that holds the battery on drone 310 can be a plastic 3D printed custom lightweight flexible but strong part. It should be designed to work with almost any drone with slight modifications.

FIG. 4 illustrates the process for swapping a battery/payload according to one example embodiment. First in step (1), the drone 310 lands on base 304. Importantly, the drone can land at a random position on base 304 up to a significant divergence from facing the arm exactly including more than, e.g., 20-30 cm left or right of the center of the servicing area, as well as more than, e.g., 20 degree off center directional face of the front of the drone battery bay. Conventional systems often require the drone to land and subsequently be moved to a predetermined position. The angle and distance to the arm 302 can then be determined and used as the “home position”. Using computer vision, the system can scan and detect the drone 310 and bay 312 using camera 308, in step (2). At this point, the system can also control arm 302 by moving it left or right on rail pulley system 303, or other extension system, such as a hydraulic extension system. The system can then control arm 302 to move towards drone 310, grip drone bay 312, insert the key into battery case 900, rotate the key, and pull it towards arm 302.

In step (3), the system controls arm 302 so as to remove the battery, and place it into charging station 306. In step (4), the system can control arm 302 to remove a charged battery from station 306, move arm 302 back into position to install the new battery into drone bay 312. In step (5), the drone 310 can then continue on its mission. A challenge with conventional drones, is the battery connectors, which are typically an xt60 or xt90 connector and which require a lot of pressure between the connectors to create a strong circuit, i.e., upwards of 12 lbs. One problem is that putting, e.g., 12+ lb. of force on, e.g., a 3 lb. drone causes the drone to simply be pushed back instead of seating the battery properly. The lighter the drone, the easier it gets pushed back when the battery is inserted. To mitigate this for smaller drones, system 300 can implement a number of unique solutions that enabled a strong amount of force on the battery as it moves forward, while eliminating direct pressure from the drone.

Certain embodiments use a locking mechanism that has a rotational axis, such as described in the ‘013 Publication. This allows, relatively, a lot of force to be applied as the connectors on the battery are pushed in, because the drone legs bear the downward force to the floor when the lock is rotated. In addition to the connectors connecting to the drone, a unique additional benefit is that the battery is locked in place by the connectors simultaneously.

Other embodiments include a different rotational mechanism that, as the lock is turned, enables the battery case to grip the battery bay and push the arm and therefore the battery forward into the drone bay 312. Such a design requires more precision and synchronization as the robotic arm 302 has to move forward as the battery locks itself into place.

In other embodiments, the arm 302 comprises a mating mechanism, such as grippers that mate the arm to the drone, and then while the drone 310 and arm 302 are secured to each other - uses a mechanism to pull the battery on to the arm or push the battery in. This can be achieved using two grippers that grip the battery bay 312 of the drone 310 with ball bearings, which mate with an indentation in an extrusion on the bay 312. The indentation on the extrusion, can be shaped like a semi-circle on both sides, so the grippers grip, i.e., the ball bearings are forced into the center of the indentation perfectly aligning the arms with the battery on the drone so it can pull out the battery with a simple motor moving forward, unlocking the battery with a key, and moving the battery backwards in to the arm. In certain embodiments, this can also be achieved using one gripper or a mating activated by pressing into the drone - and causing a latch to attach, or no gripper and relying on the computer vision alone for alignment, and the key and locking mechanism for removal.

Arm 302 can comprise, therefore, an end effector, which houses a sliding motor with a “key” on a key motor that can be inserted into the battery case 900, which is locked onto the drone, and turns to unlock the battery, and allowing the sliding motor to remove the battery by retracting backwards. The battery is locked to secure the battery to the drone 310 during the flight, so the battery doesn’t fall out, or get loose during operation. Having two end effectors on the end of the robotic arm 302 can greatly reduce the time it takes to swap out a battery. For example, the two end effectors could be 90 or 180 degrees from each other, with one end effector holding a ready charged battery and the other empty ready to accept the spent battery. Then instead of returning to the charging bay after removing the spent battery, the end effectors simply swap their position and the second end effector replaces the ready charged battery into the drone.

The grippers serve as a method to hold the drone 310, but double as a tool that adds precision to the swap. Since the battery is brought to the drone 310, the drone can be held in whatever place it lands. In contrast, many conventional systems that swap batteries, have systems that grip the legs of the drone and move the drone to a central position, and hold it as the battery is swapped from a stationary swapping mechanism. It should be noted that other mating mechanisms can be used.

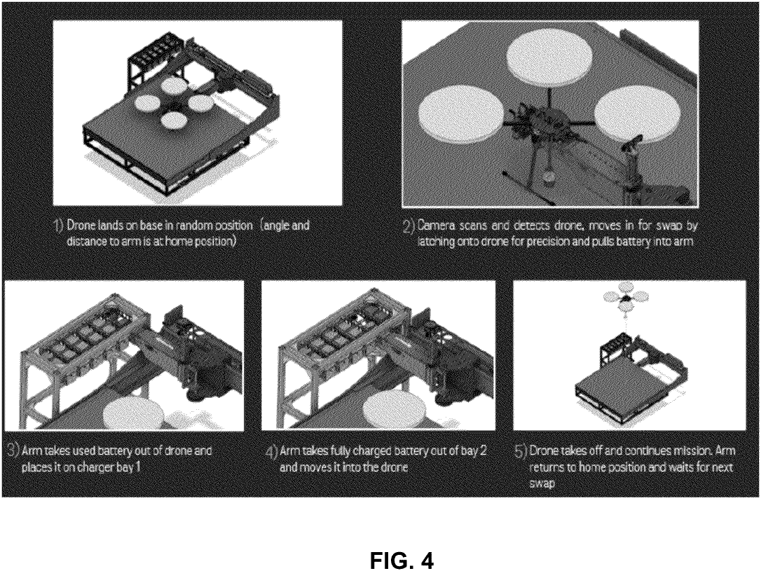

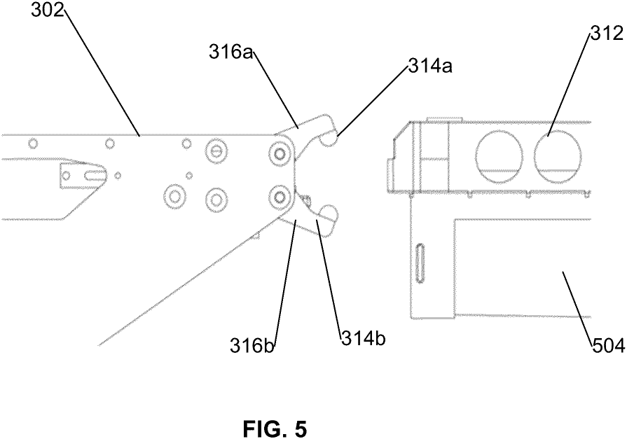

FIG. 5 is a diagram illustrating example grippers 314 a and b on the end of effectors 316 a and b, mounted on the end of arm 302. These grippers 314 a and b form a ball bearing type gripper that can grip indentations on the drone, bay, or a rail device designed to enable batteries of different sizes to be used with each drone, as described below. The grippers can actually align a key on the end of arm 302 as described in more detail below adding a further redundancy to the vision. It should be noted that arm 302 can comprise one set of effectors 316a and b, or multiple sets.

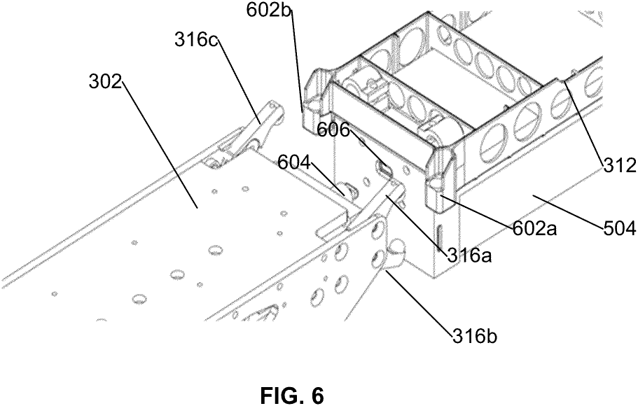

FIG. 6 illustrates that the arm 302 can indeed have one set 316 a and b on one side and another set 316 c and d (not visible) on the other. The grippers 314 a, b, c, and d are configured to grip corresponding grip portions 602 a and b, in this case on a battery installation rail 312 that is attached or built into drone 310. What can also be seen in FIG. 6, is the key 604 on arm 302 and the corresponding lock on battery case 900, which holds the battery 504. Thus, arm 302 can move into position in front of battery case 900 and grippers 316 a-d can grip portions 602 a and b positioning arm 302 such that the sliding motor housed in arm 302 can move the key forward while the drone is held in place and insert key 604 into lock 606.

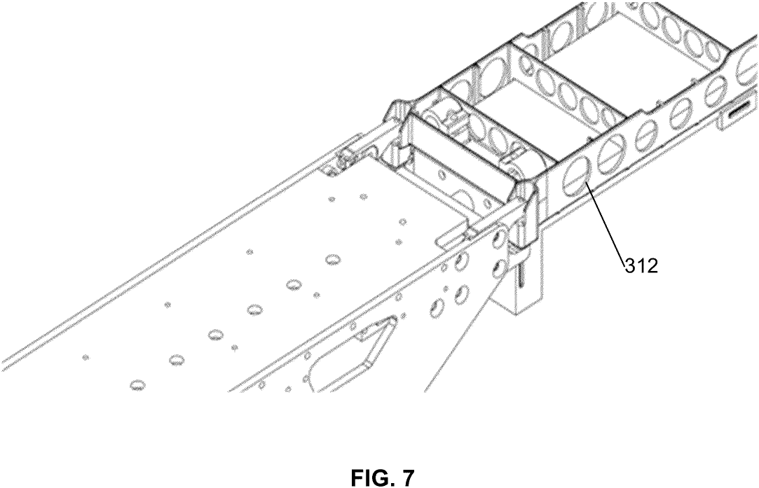

FIG. 7 shows the arm 302, with the key 604 inserted in lock 606.

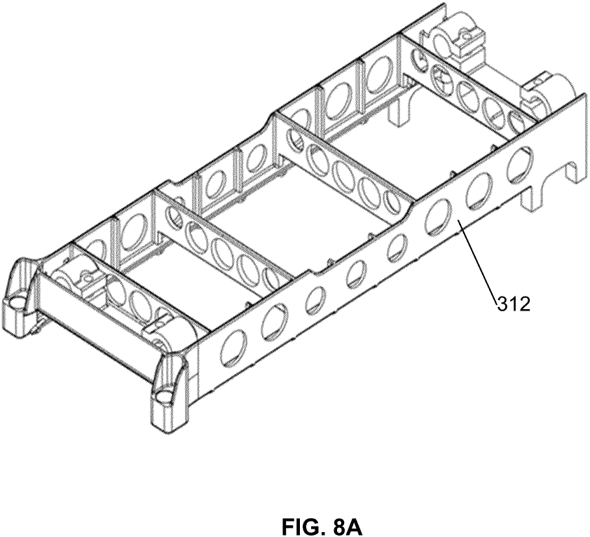

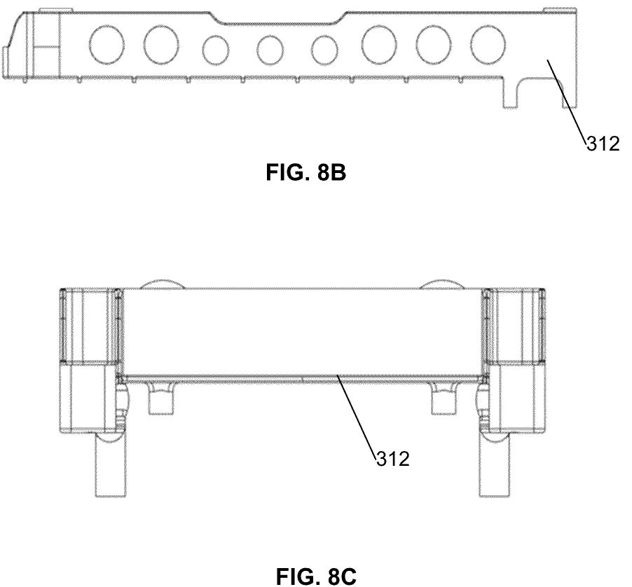

FIGS. 8 A-C illustrate the installation rail 312. Rail 312 allows the system to work with different size batteries, e.g., in conjunction with case 900 (described below). In other words, rail 312 is attached to drone 310 and includes, e.g., rails that can accept case 900. Case 900 can then be configured to accept batteries of different sizes. And as previously illustrated and described, arm 302 can then be configured to interact with the rail 312, and battery case 900, which provides a consistent interface for arm 302 and grippers 314a-d.

FIGS. 8B and C provide side and head on views of installation rail 312.

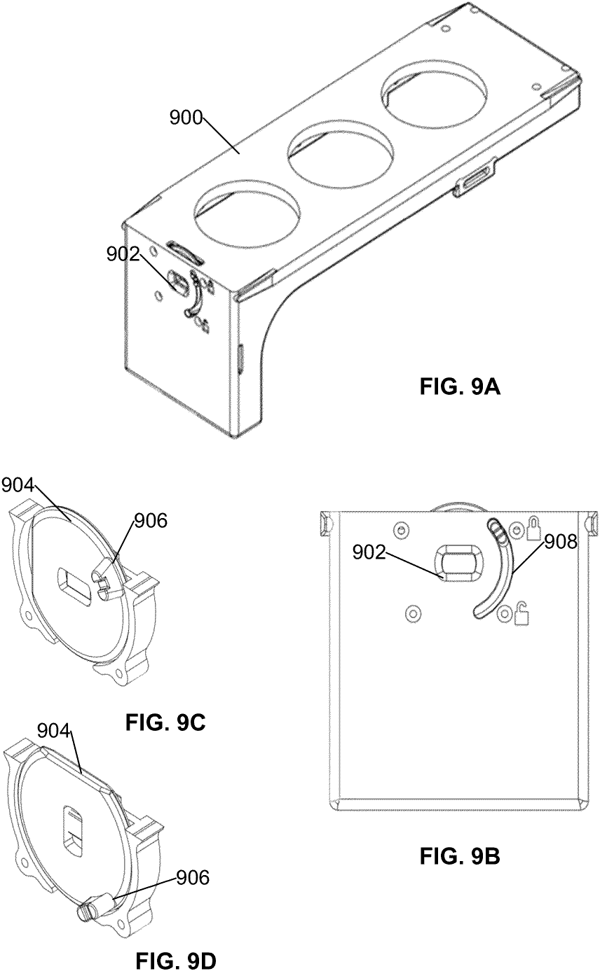

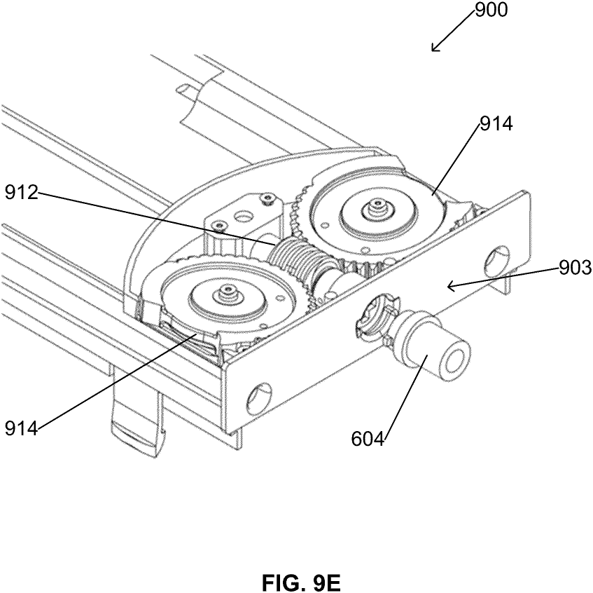

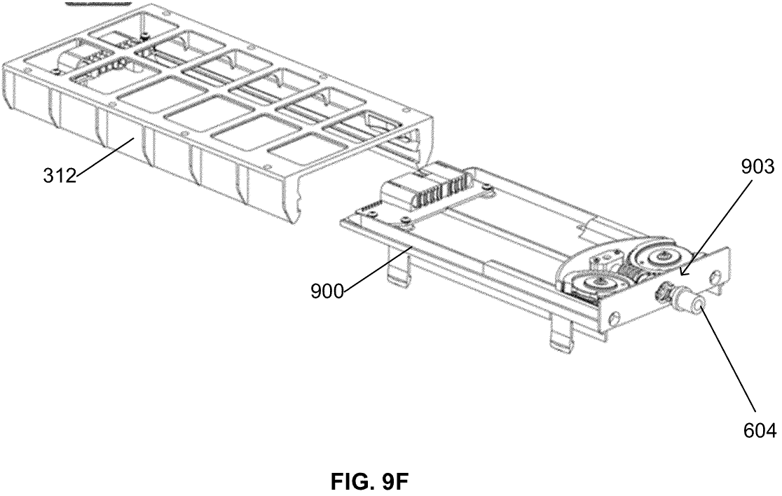

FIGS. 9A and B illustrated a battery case 900 that can be installed into rail 312. The battery is installed in the case and then the case is installed in the rail 312. As can be seen, case 900 can include the lock 902. As can be seen in FIGS. 9B-D, case 900 can also include a mechanism that indicates whether the lock is in fact locked, and enables manual manipulation of the lock and removal or insertion of the battery case 900 with or without a tool or key. Here the lock comprises a wheel 904 with a protrusion 906 in a slot 908. As the lock 902 is turned, the wheel 904 turns and the protrusion 906 moves within slot 908 to indicate the status of the lock.

Thus, drone 310 and battery bay 306 can be configured with rail 312 that allows case 900 to be inserted into drone 310 or battery bay 306.

It should also be noted that rail 312 and/or case 900 can be used with other payload such as packages in order to load or unload the payload.

FIGS. 9E - 9F illustrate another embodiment of a locking mechanism design that may be used to lock and release the battery bay or case 900 from an installation rail 312 of the drone. The mechanism of FIGS. 9E - 9F may be used with any of the above embodiments of the case 900 and rail 312. FIG. 9E shows a case/battery bay 900 with a lock 903 and a key 604 approaching the lock 903. The locking mechanism of the lock 903 includes a worm gear 912 that is used to rotate two gears 914. When the worm gear in the middle 912 is rotated clockwise (by the key 604), the two other gears rotate towards the key and fill in a space on the rail 312, locking the case 900 in place. When the key 604 rotates counterclockwise, the gears rotate to free up that space, and allow the case 900 to be removed

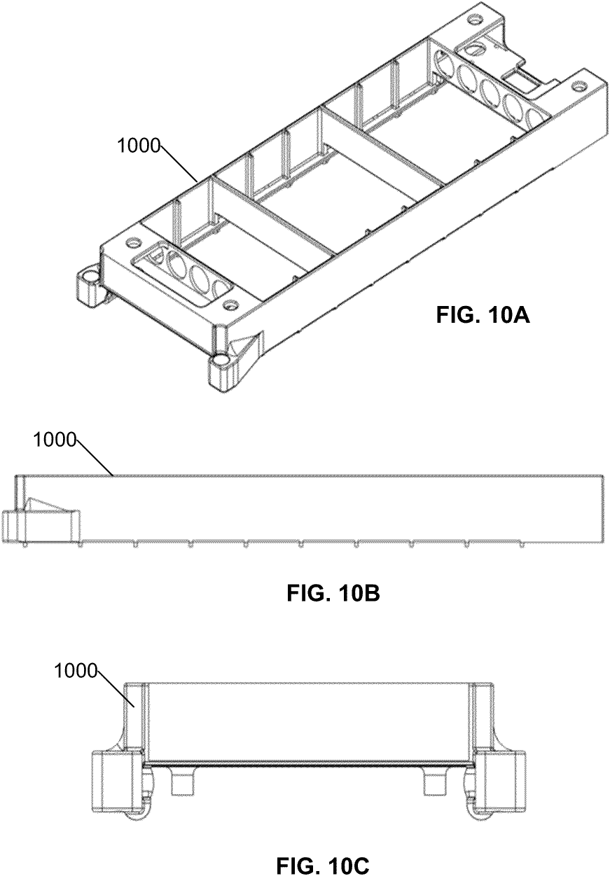

A slightly different rail design can be used with the battery bay 306. Such a rail 1000 is illustrated in FIGS. 10A-C, but it will be understood the concept of operation is the same, i.e., the battery can be mounted in a case, e.g., case 900 and arm 302 can be configured to remove the case 900 and battery from the rail 312 in drone 310 using grippers 314a-d, move into position, e.g., via rail 303, and insert the case 900 and battery into the battery bay or charging station 306 via rail 1000 installed therein. Or vice versa.

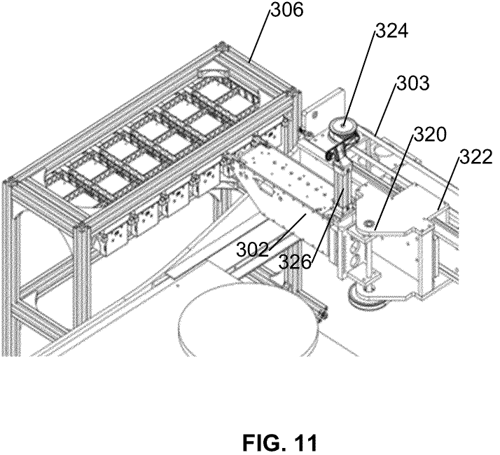

FIG. 11 illustrates arm 302 as it either removes or inserts a battery into charging station 306. As can be seen, arm 302 can be coupled with or mounted on rail 303 via a mating mechanism or linkage 322. A pulley system 324 can then be coupled with the linkage 322 to move the arm back and forth on rail 303. A motor (not illustrated) can be configured to cause the arm 302 to pivot around post 320.

As can be seen, a post 326 can also be included in arm 302 or linkage 322 and a motor (again not illustrated) can be included that can drive arm 302 up and down post 326 in order to change the height of arm 302, e.g., as needed for different sized drones.

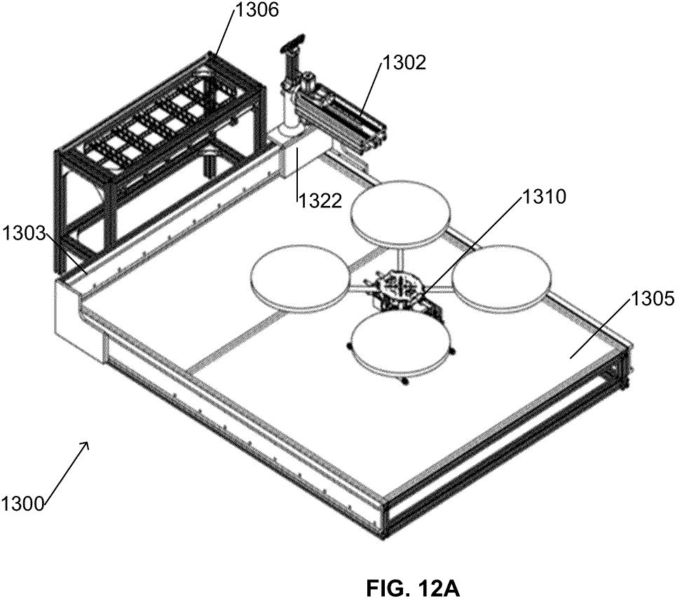

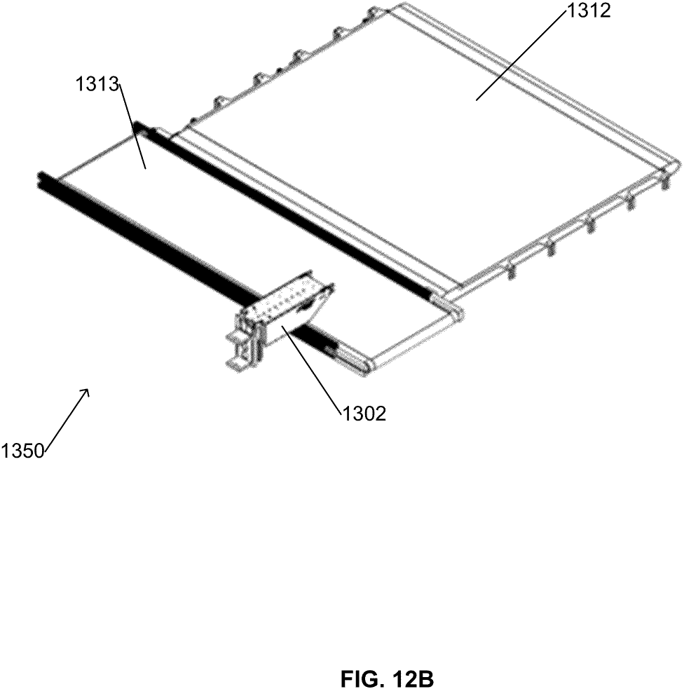

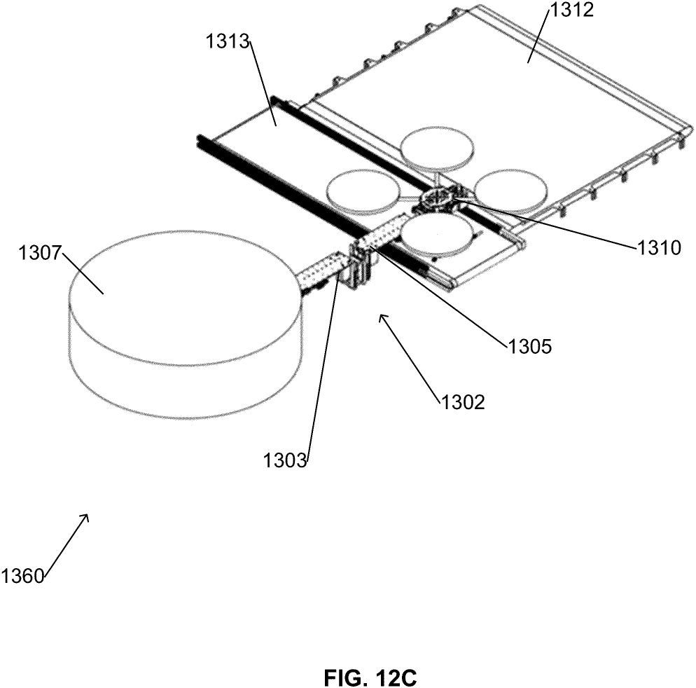

FIG. 12A illustrates an example drone hub 1300 (with an alternative rail mechanism for positioning the arm) in accordance with another example embodiment. Here, as can be seen the charging station or batter bay 1306 can be behind the arm 1302, which can be mounted to a different type of rail 1303 via linkage mechanism 1322. The arm 1302 is in the ready position, i.e., moved to the side to wait for the drone to take off or land, giving drone 1310 unobstructed landing and take-off space.

Arm 1302, or 302 for that matter, can be capable of swivelling for the arm to go 180 or more degrees in either left or right direction or both. In this or other embodiments, the arm 1302 can be configured such that it can swivel up to a full 360 degrees.

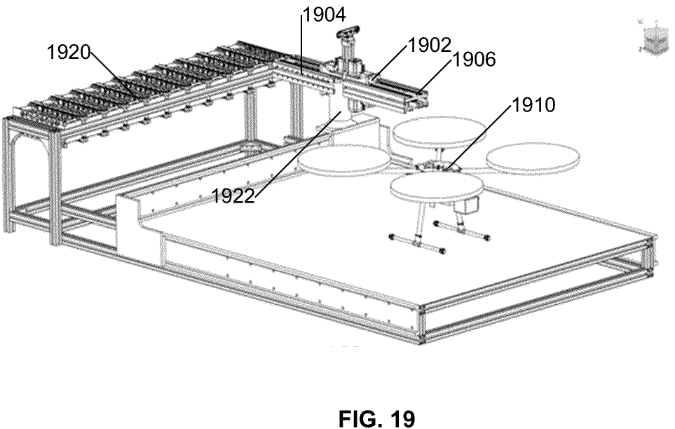

It should be noted that a portion 1305 of the base of hub 1300 can comprise a conveyor belt 1312 to move drone 1310 into place with respect to arm 1302. Thus, the conveyor can move the drone 1310 toward arm 1302 and then away from it. The front portion of the base can comprise a second conveyor 1313 to move the drone, e.g., from left to right in the example of FIG. 12A. FIG. 12B illustrates an example of the drone hub 1350 that includes two conveyor belts 1312 and 1313 for positioning the drone 1310 with respect to the arm 1302. The arm 1302 may be the same arm 302 or 1302 as described in the embodiment of FIG. 12A. The charging station is not shown in FIG. 12B, but may, for example, be the same type of charging station 1306 as shown in FIG. 12A or any other types of charging stations disclosed herein. In one example, FIG. 12C shows a drone hub 1360 similar to the drone hub 1350 of FIG. 12B, but with a round battery carousel 1307 type of charging station/bay. The arm 1302 may include two arms or two arm sections 1303/1305 separated by 180 degrees, as shown in FIG. 12B. This embodiment of the arm is described in greater detail later in the disclosure (e.g., in description of FIG. 19). The arm sections 1303/1305 may rotate between the battery carousel 1307 and the drone 1310 such that, for example, one arm section removes a payload/spent battery from a drone while the other arm section is ready with a new payload/battery.

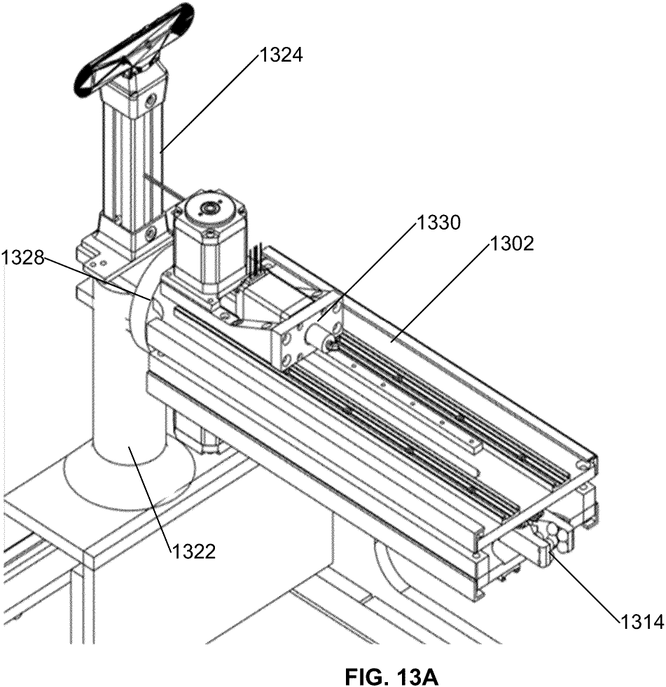

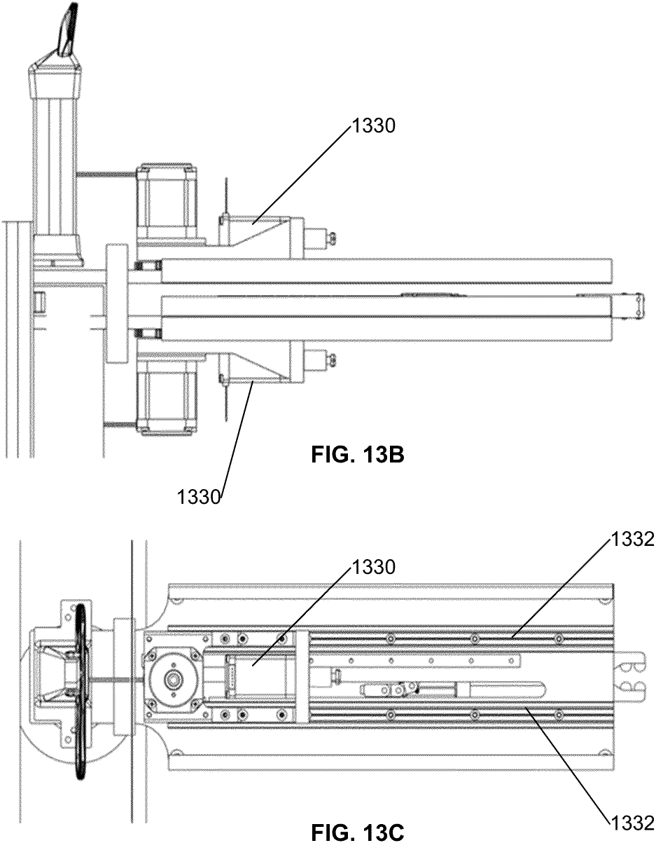

In the examples of FIGS. 12A-C, arm 1302 (or arm sections, for FIG. 12C) may be a double-sided arm capable of holding a payload/battery (either one of each or 2 of either) on top and bottom. As illustrated in more detail in FIGS. 13A-C, arm 1302 (or each arm section) is modular and consists of three main parts, the middle section which houses the grippers 1314, and the top/bottom sections that each hold a sliding motor and key mechanism 1330. Each section can be used in combination or isolation to carry out various tasks. Arm 1302 can also move up and down on post 1324 to allow the z-axis position of arm 1302 to be changed.

Thus, the top section can be holding a battery while the bottom portion is empty, or vice versa. The arm 1302 and/or drone 1310 can be moved into position such that grippers 1314 can grip the drone 1310, key mechanism 1330 can slide forward to unlock the battery from the drone 1310 and remove it. The arm 1302 can then be raised up, or lowered where the battery is on top and the bottom section is used to remove the battery, and the battery on the topsection can be inserted into the drone 1310.

Alternatively, or in addition arm, 1302 can be coupled with linkage mechanism 1322 via a swivel engagement mechanism 1328 that allows the arm to swivel such that the bottom section moves to the top, and the top to the bottom.

FIG. 13B illustrates a side view of arm 1302 where the top and bottom sliding motor and key mechanisms 1330 can be seen.

FIG. 13C is a top view and displays the tracks 1332 that can be included for the top and bottom sliding motor and key mechanisms 1330 to move forward and back on.

Depending on the embodiment, each of the 3 sections, i.e., the top motor track, middle gripper, and bottom motor track, can be swapped out, or removed completely, e.g. for a larger or different drone, this would allow the base station to be upgraded for a new drone model, or different swapping system. For example, a station that had a battery on top, and payload on the bottom, can be reconfigured to have a refuelling system on the bottom instead of a payload system.

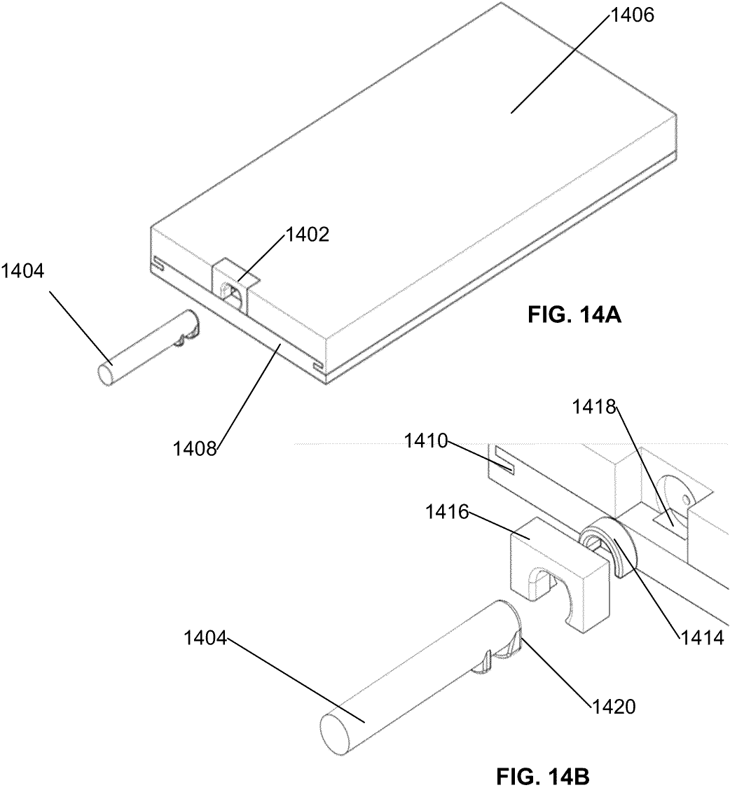

There are numerous other variations and alternatives for the arm, battery bay/charging station, and conveyors as will be described in more detail below. But first, FIGS. 14A and B illustrate an alternative embodiment for the locking mechanism where the locking mechanism 1402 is on the drone bay or charging station, as opposed to the battery or payload case as described above.

In the example of FIGS. 14A and 14B an installation rail mechanism 1406 can be affixed to the drone and to the charging station and include locking mechanism 1402. FIG. 14B illustrates that rail 1406 can itself have a mechanism, such as rails 1410 configured to engage a battery case 1408 or a package as discussed below. FIG. 14B also illustrates the sub-components of locking mechanism 1402, including ridge 1420 on key 1404, which engages disc 1414 through cover 1416 and turns disc 1414 such that it engages and disengages indentation 1418.

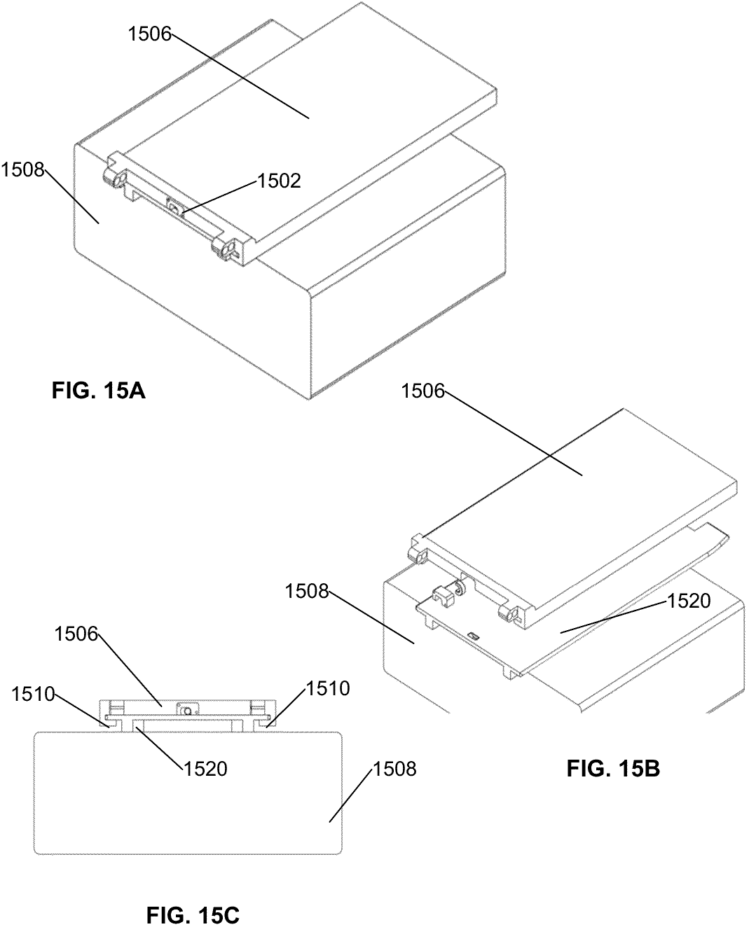

As can be seen in FIGS. 15A-C a similar type of installation rail mechanism 1506 to mechanism 1406, also with a locking mechanism 1502 thereon. A “plate” 1520 can then be attached to a larger battery or package 1508. The plate 1520 can then be configured to engage rails 1510.

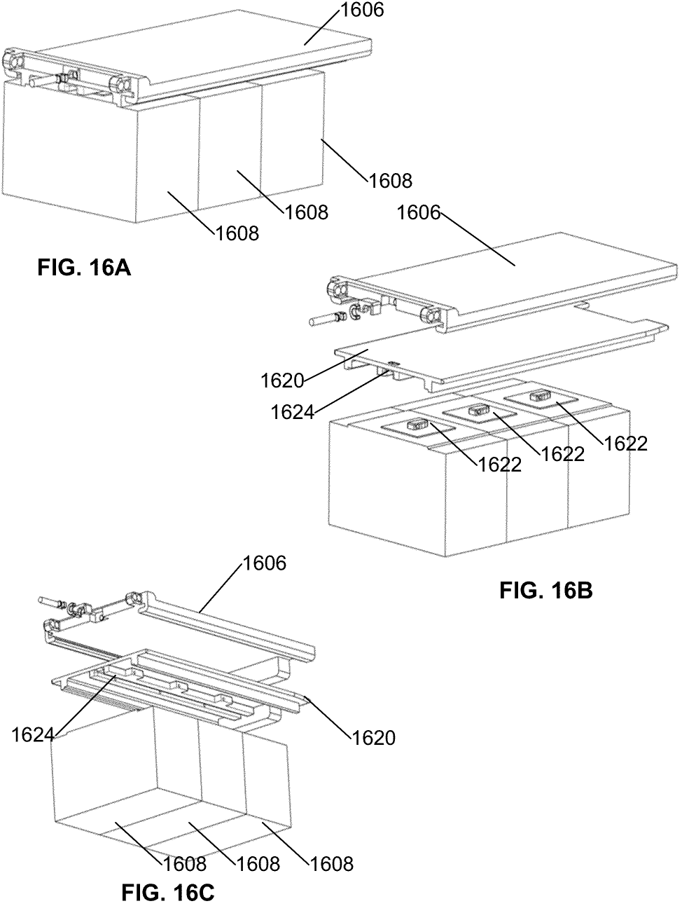

FIGS. 16A-C illustrates an embodiment in which the plate 1620 that acts as a dropping mechanism. Here the plate 1620 is designed not to drop from the drone attached to a payload 1608, but to manage multiple payloads 1608. Each of the payloads 1608 has a small “loop” or “hook” like extrusion 1622. The payloads are attached to the payload rail 1624 via the extrusion 1622 (e.g., the extrusions 1622 slide into the payload rail), and are then locked in place with, e.g., a servo motor. Each payload 1608 can then be dropped individually at the correct location.

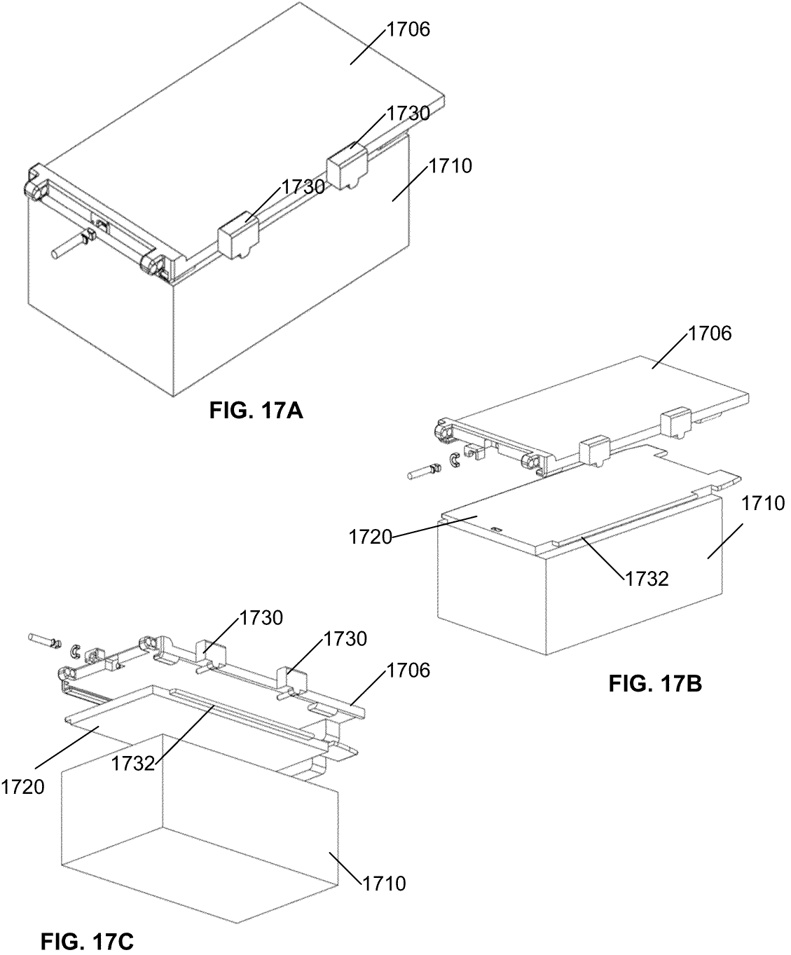

FIGS. 17A-C illustrate another embodiment in which bay 1706 acts as a dropping mechanism for plate 1720 and payload 1710. Here one payload 1710 is held in place using two servo motors 1730 that serve as the rail. Lip 1732 on plate 1720, and specifically extruding parts on the bay1706, allow the plate 1720 to slide into the bay 1706. Once the motors 1730 move out the way, the plate 1720 falls out. What this design accomplishes, is that when inserting the plate 1720, the bay 1706 supports the plate 1720 and payload 1710 until the plate 1720 reaches the end of the bay 1706, at which point it loses interaction with the right side of the bay 1706 and is suspended only by the servo motors 1730.

Now various alternative embodiments for the arm mechanism, configuration and operation will be described, although it will be understood that various aspects of the different embodiments can be used together with aspects of other embodiments.

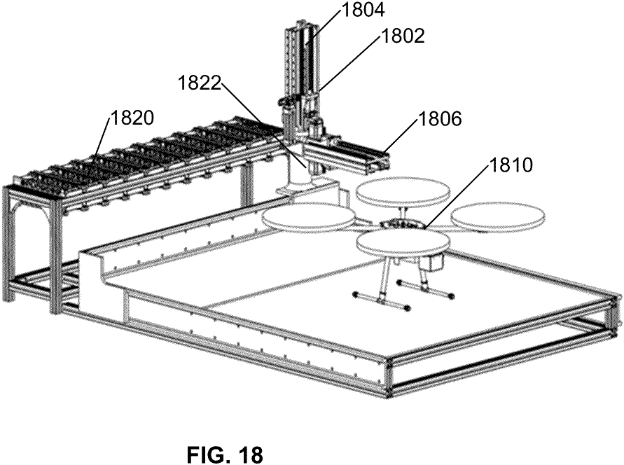

In FIG. 18, it can be seen that arm 1802 comprises two sections 1804 and 1806 that are arranged at 90 degree angles from each other. The linkage to linkage mechanism 1822, then allows the sections 1804 and 1806 to be rotated into position. For example, section 1806 can be configured to “grab” a battery or payload from rack 1820 by being rotated 180 degrees from the position shown in FIG. 18. Section 1806 can then be rotated back and rotated into the vertical position that is now occupied by section 1804, such that section 1804 is in the position of section 1806 as shown. Arm 1802 and/or drone 1810 can then be moved into position such that section 1804 can remove a battery or payload from drone 1810. Then section 1806 can be rotated into position to load the battery or payload stored thereon. Additionally, like in FIGS. 13A-C, sections 1804 and 1806 can both have a motor on each side and can hold a payload/battery on each side. In another embodiment, they can swivel to rotate the position of the payload/battery from top to bottom or vice versa.

In the embodiment of FIG. 19, the arm sections 1904 and 1906 are separated by 180 degrees instead of 90 degrees. But the principle of operation is similar, in terms of rotating the sections 1904 and 1906 into and out of position so as to grab a payload or battery, unload a payload or battery, load the payload or battery and, e.g., place the payload or battery into rack 1920 or the appropriate spot or position. The sections 1904 and 1906, similarly to the arms described in FIGS. 13A-C, can both have a motor on each side and can hold a payload/battery on each side. In another embodiment, they can swivel to rotate the position of the payload/battery from top to bottom or vice versa.

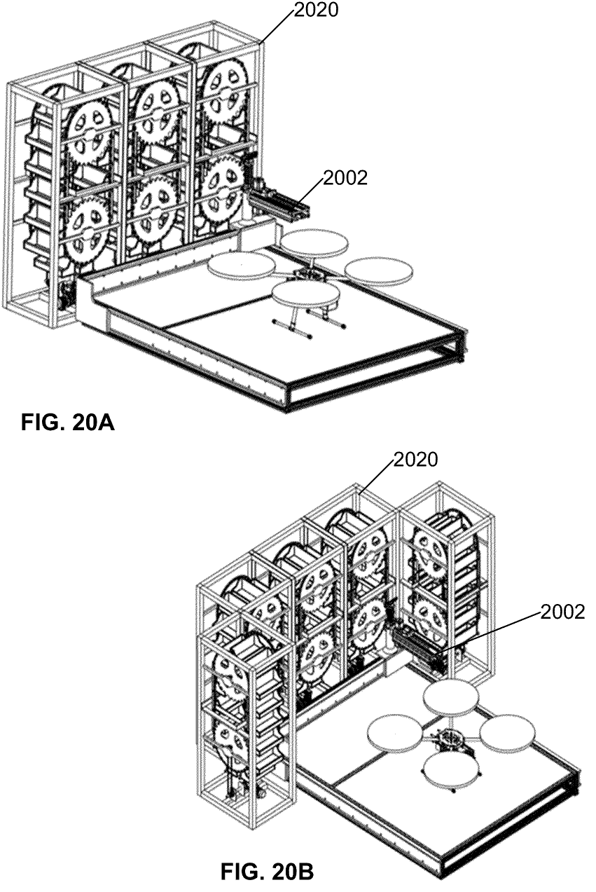

In the embodiment of FIGS. 20A & B, the racks or bays 2020 comprise wheels that hold multiple, e.g., ten battery bays (or payload bays, or a combination of battery and payload bays). Each battery bay charges the battery, and each battery/payload bay can turn 180-360 degrees. The bays can have batteries/payloads loaded from the back and additional wheels can be located on the sides as illustrated in FIG. 20B. By using this design, the package/payload can stay in the upright position the entire time.

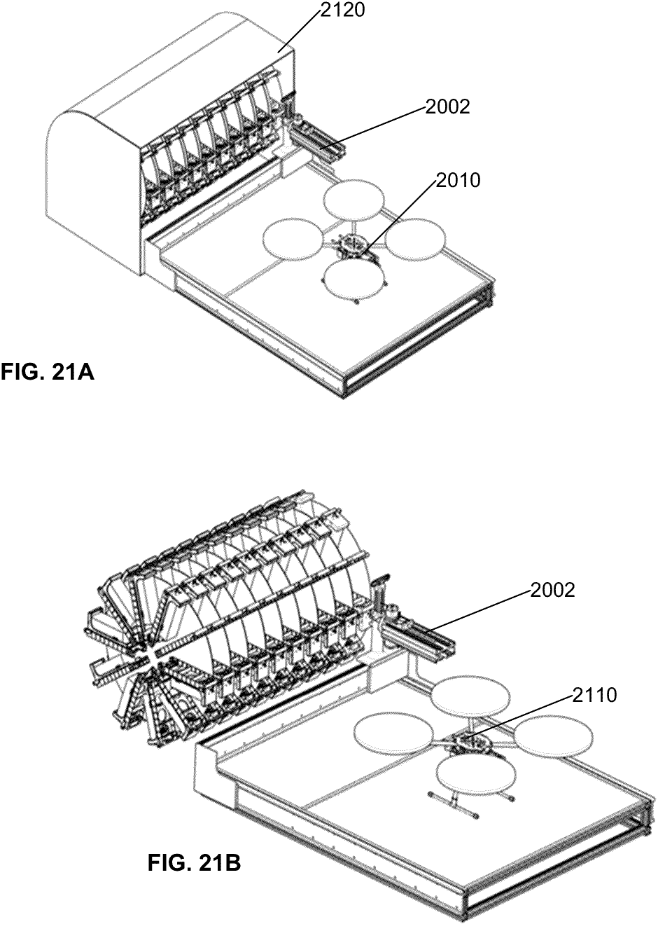

The arm 2002 can have or remain in a fixed Z axis, and retrieve the battery from the same height each time. This can be a simpler design, and in turn very reliable. One motor (not shown) can be configured to turn all the battery/payload bay wheels, for example in FIGS. 20A-B (and in FIGS. 21A-B and 22A-B, described below) or an additional motor to control which wheel turns, or an individual motor per wheel or a combo or part of any of those, depending on the embodiment. Thus, the arm stays optionally at one height, and can go to the same points for each wheels swap. Additional robots/systems can interact with the storage bays from the other side. And a smaller square foot form factor is achieved utilizing height to hold more batteries/payloads.

In embodiments of FIGS. 21A & B, rack 2120 can comprise rotating wheels with multiple charging bays. One arm 2002, can service multiple drones 2110. Packages and/or sensors can be loaded here as well, in the same manner as batteries and can be loaded into the back of rack 2120.

In the embodiment of FIGS. 21A & B, rack 2120 can comprise wheels that can have different size bays for different purposes, such as different size or variations of batteries, or different payloads. One arm 2002, can service multiple size drones 2110, collecting the right payload for the right drone. Packages can be loaded here as well, in the same manner as batteries, as well as sensors, or other loadable items, and can be loaded into the back of rack 2120.

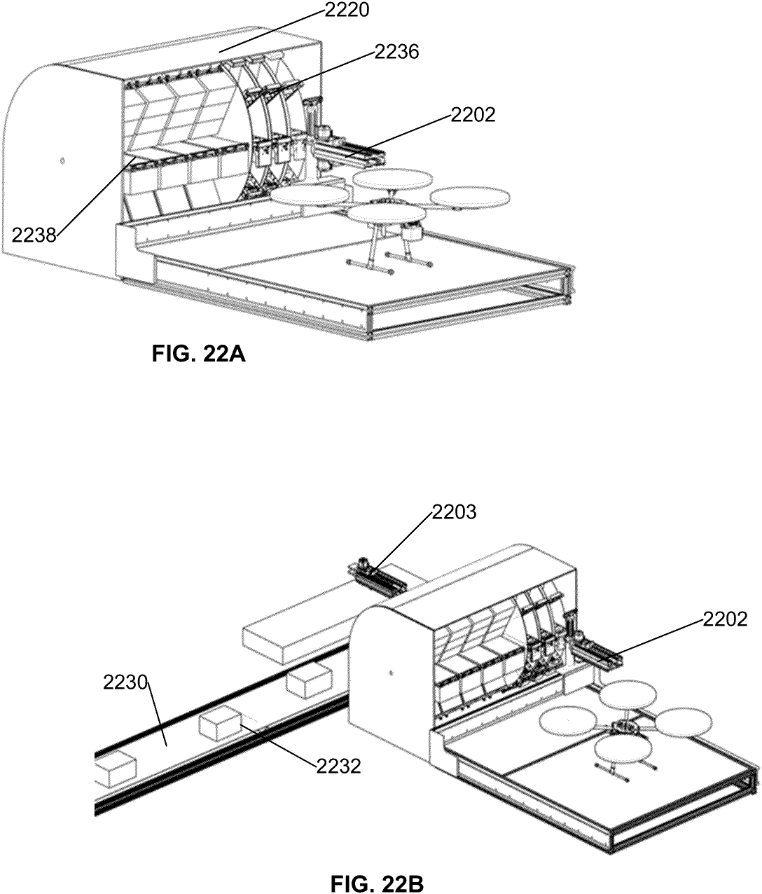

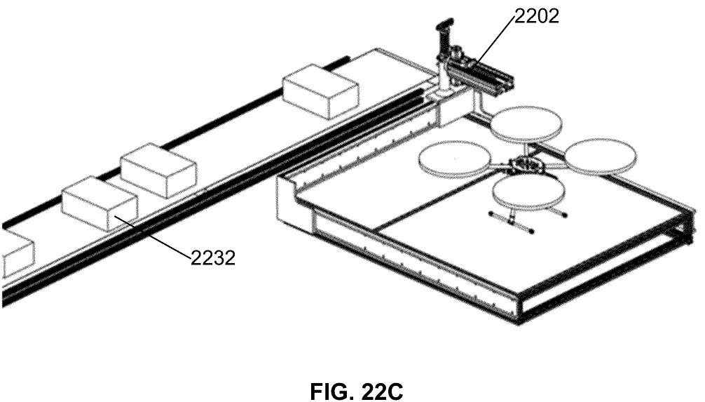

In the example of FIGS. 22A & B, bay 2220 can have a plurality of section, e.g., sections 2236 and 2238 that can be configured with different sized batteries and/or other payloads and/or sensors. As can be seen in FIG. 22B, a conveyor 2230 can bring payloads 2232 to the back of rack 2220, and an additional arm 2203 at the back “pushes” payloads 2232 into the correct bay. Arm 2203 can be configured to move between bays to push the correct package 2232 into the correct bay. As with the embodiments of various arms described herein, arm 2203 can have additional axis of operation as well.

As seen in FIG. 22C, a single arm 2202 with no bays can be configured to grab payloads/batteries off a conveyor and load them onto a drone. The same arm 2202 can unload payloads/batteries from a drone and deposit them onto a different or same conveyor belt.

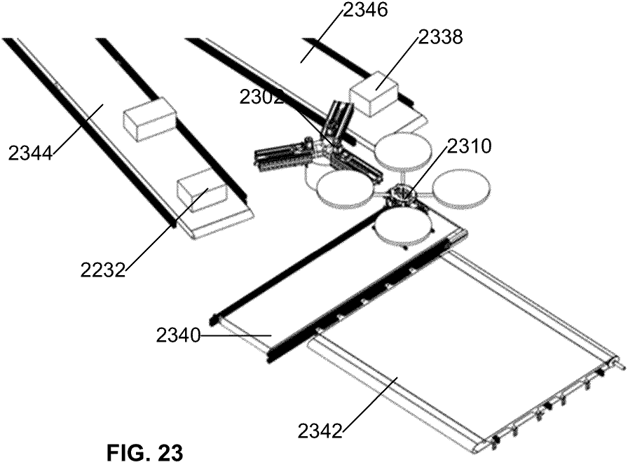

In the embodiment of FIG. 23, a stationary or mostly stationary arm 2302 can have three sections configured to interact with three conveyor belts at the same time. For example, the first conveyor (e.g., including conveyor sections 2342/2340) can bring a drone 2310 to the location where the arm is located and can be aligned to the drone. The second conveyor 2344 can bring payloads/batteries 2232 to the arm 2302 and the third conveyor 2346 can take returning payloads 2338 away from the arm 3202. In one (120-degree) rotation of the arm 2302, (i) a first section of the arm can unload the drone and bring the unloaded payload 2338 (or depleted battery) to a conveyor belt 2346 to be returned/recharged, (ii) a second section of the arm can acquire a new payload/battery and get ready to place it into the drone, and (iii) the third section of the arm can deposit a previous unloaded payload/battery onto the third conveyor 2346 and swing over to the second conveyor 2344, ready to receive a new payload/battery.

Additionally, like in FIGS. 13A-C, the three individual sections of the arm 3202 can each have a motor on each side and can hold a payload/battery on each side. In another embodiment, they can swivel to rotate the position of the payload/battery from top to bottom or vice versa.

The arm 2302 of FIG. 23 has three section, but it will be understood that more or fewer or other configurations of multiple arms can be used.

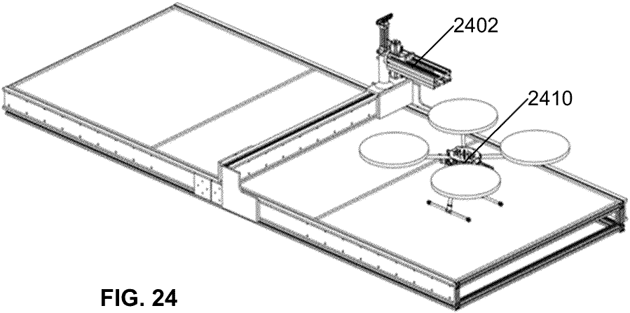

FIG. 24 illustrated an embodiment in which an arm 2402 can service multiple drones 2410, one on each side in this case. Any of the arm payload bay implementations could be used with such an embodiment.

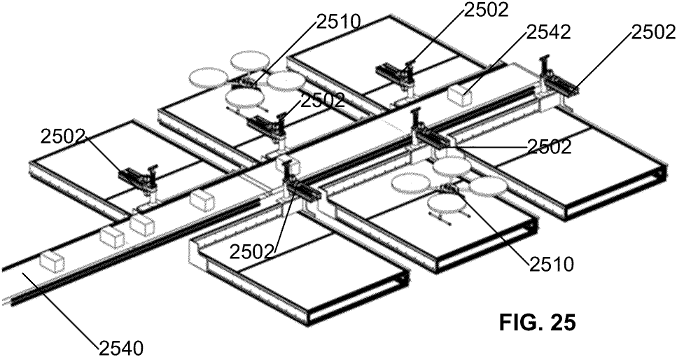

FIG. 25 illustrates an embodiment of a cell of multiple drone hubs using a conveyor belt to supply the payload/battery to the drones. In the example, multiple arms 2312 can service multiple drones 2510 using a conveyor 2540 delivering payloads 2542, but other configurations with more or less arms 2312 and/or other types of payload racks as described herein. In one embodiment, a conveyor carrying returns may run in the opposite direction. This type of configuration of a cell of multiple drone hubs may allow for scaling to large numbers of payloads and drones (to be serviced at the same time).

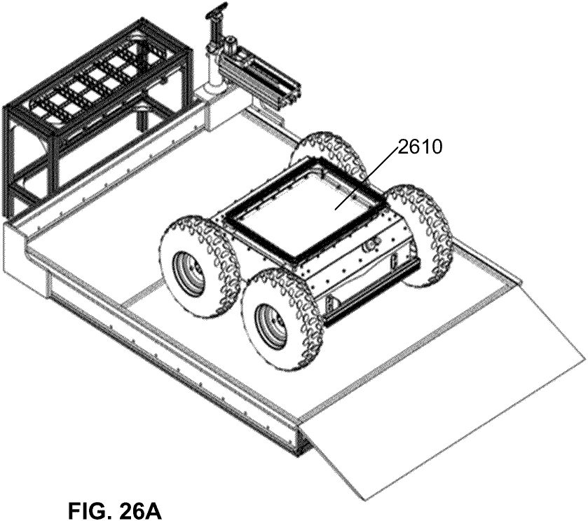

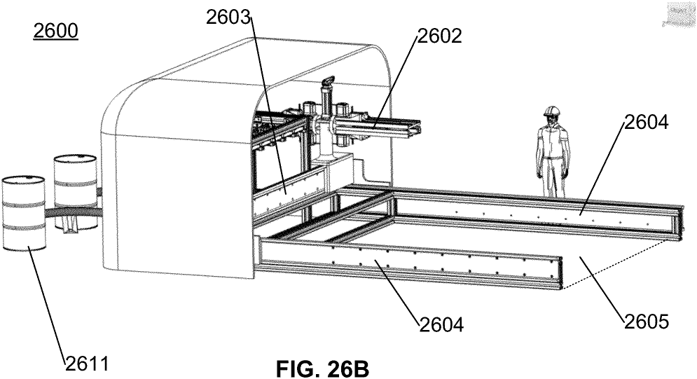

FIG. 26A illustrates that different types of drones 2610 or vehicle, including autonomous or semiautonomous (or even fully manual) vehicles, etc. can be used with the systems and methods described herein. For example, a UGV can be configured to use the same technology to remove and replace its battery (power source) or payload using a ramp (as shown in FIG. 26A) or by dropping the base to ground level (or removing it altogether, as will be described below with respect to FIG. 26B).

FIG. 26B illustrates that a drone hub or drone station 2600 of the present disclosure can operate without a base/landing pad. For example, a drone 2610 (e.g., an autonomous or semiautonomous vehicle or flying drone, etc.) can land/arrive in a specified area (e.g., drone servicing area 2605) within reach of the arm 2602 of the drone hub 2600, and hub system can adjust height (z-axis), orientation, and/or (horizontal x-y plane) position of the arm 2602 in order to reach and service the drone 2610, even if the drone is at ground level. The arm 2602 position may be changed using one or any of the arm movement features described elsewhere in the disclosure. For example, rail 2603 (along with a pulley system, not shown) may be used to move the arm 2602 side to side. The arm 2602 may have any configuration and include any of the features discussed elsewhere in the disclosure with respect to drone hub arms.

FIG. 26B shows the drone servicing area 2605 partially surrounded by service area rails 2604. The service area rails 2604 may, for example, serve to visually indicate to drones the limits of the drone servicing area. Alternatively or additionally, the service area rails 2604 may be used to extend the range of the arm movement, specifically, the horizontal positional movement of the arm 2602. For example, the service area rails 2604 may be included in the arm rail system, such that the arm 2602 may be moved not just side to side (along rail 2603), but deeper into the service area 2605. In another embodiment, the ground-based drone hub 2600 may operate without the service area rails 2600. In this case, a drone may have to approximate its landing location (or, for example, use sensor(s) and/or feedback from the drone hub to stop at an appropriate location (within reach of the arm).

In one example, the ground-based drone hub 2600 could be used to swap batteries/payloads, similar to other drone hub embodiments of the disclosure. In other examples, an open, ground-based drone hub 2600 shown in FIG. 26B may be used to fuel and supply heavy (e.g., 50 or 250 kg) drones, for example, using storage banks or barrels 2611. The arm 2602 of the drone hub 2600 may include effector(s) to open/unlock a drone tank and nozzle(s) (connected to one or more barrels 2611) to supply the drone with, for example, gas, pesticides, fertilizer, etc. The ground based station 2600 may have any of the drone hub configurations described elsewhere in the disclosure (where the battery or payload bay is be optionally replaced or augmented by tanks/barrels), for example, the barrels or tanks 2611 may be (i) underneath (e.g., underground) the arm system, (ii) in a carousel configuration, (iii) behind and on the sides of the arm system, and (iv) any combination or the above or other configurations described with respect to the battery bay. Further, the ground based station 2600 may include two areas 2605 from which a drone may be serviced (similar to the configuration of FIG. 24).

Note that a person in FIG. 26B is illustrated to show a possible scale of the drone hub 2600, however this scale is merely illustrative, and the drone hub 2600 may be smaller or larger than shown.

A drone hub according to embodiments of the current disclosure could also be used to automate distribution of packages to delivery drones. For example, a locker (not shown, but which could be, for example, a standalone unit the size of a telephone booth or much larger) for holding and distributing delivery packages can include a drone landing pad/station on its roof. The locker could have several compartments holding different packages. The drone landing pad could be a drone hub with one or more robotic arms, according to various embodiments of the current disclosure, so that packages stored inside the locker could be autonomously loaded and unloaded to and from the drone. A truck or other delivery person/machine could load the packages into the locker (e.g., from the side). A mechanism would be used to move a package from the correct compartment to an elevator mechanism that would bring a correct package to the drone on the landing station and load it into the payload compartment of the drone, for example, using a 3-axis or 6-axis robotic arm, as previously described. The elevator mechanism could be configured to move packages along x-, y-, and z- axis.

In one embodiment, the locker could be an automated pharmacy distribution pod, where the delivery packages, for example, include one or more bottles/containers of mediation. A single automated pharmacy locker could have all the same or different medications. In one example, the locker could include a mechanism for dispensing appropriate amounts of medication into a bottle or container and capping the bottle before delivering the bottle/container to the drone. Alternatively, the pharmacy locker could simply hold already dispersed medications or medical supplies for distribution to the drones (e.g., in boxes, paper bags, etc.).

In another embodiment, the locker could be used to deliver groceries, other common household items, and/or any items that could be stored in a locker and delivered via drone. The drone hub of the current disclosure would allow for completely automated distribution center, with no humans involved in the operation of getting the package onto the drone.

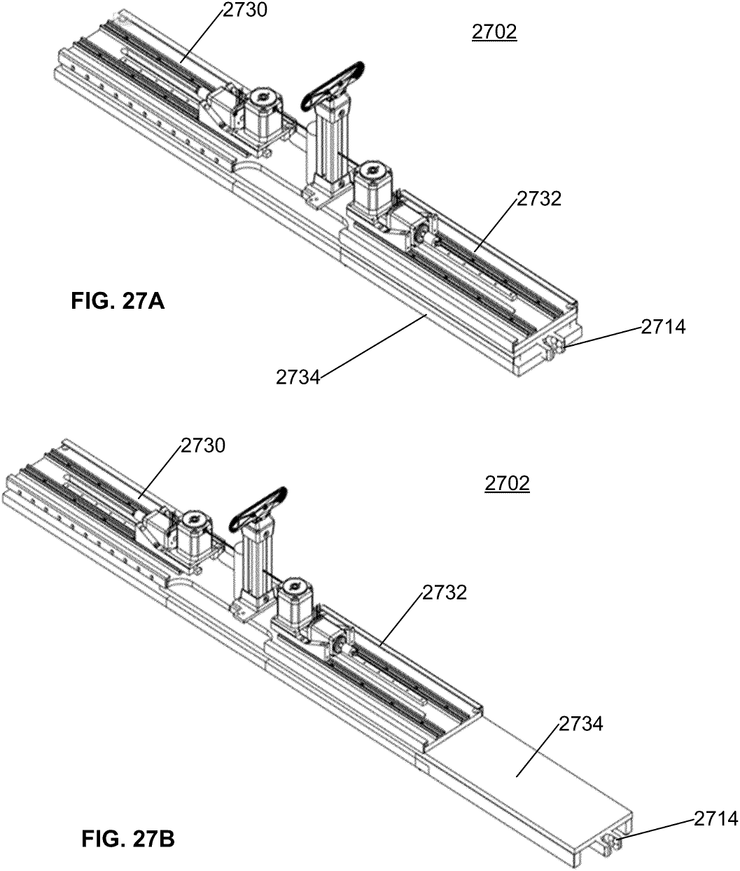

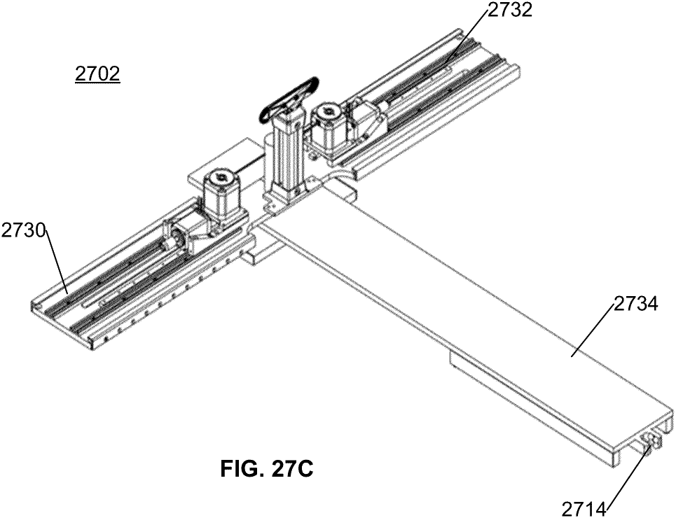

Finally, more features/embodiments of the robotic arm of the drone hub are illustrated in FIGS. 27A-C. The top part(s) 2730/2732 of the arm 2702 can be configured to rotate and/or move back and forth with the battery or payload from the drone while the bottom part 2734 of the arm (including the grippers) is still connected to the drone. FIG. 27A shows the arm 2702 in a starting position, gripping to the drone (not shown) and removing the battery. FIG. 27B shows the top parts 2730/2732 moving/sliding away from the drone, while the bottom part 2734 of the arm is still connected to the drone using the grippers. FIG. 27C, the top part(s) 2730/2732 of the arm 2702 can rotate 180 degrees while the bottom half 2734 is still connected to the drone with the grippers. The top half of the arm can have, e.g., a fully charged battery on the other side which will then be inserted in the drone, after which both parts of the arm can move back.

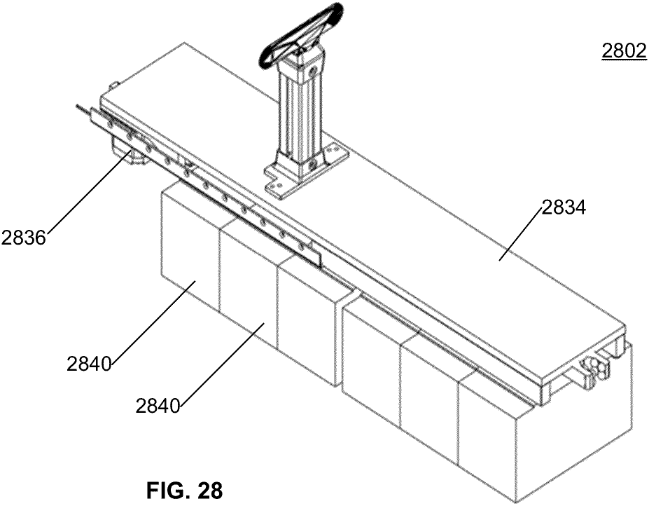

FIG. 28 illustrates an arm 2802 with a main part 2834 (similar to the bottom part 2734 in FIGS. 27A-C) and a rail system 2836 underneath that can be used to hold multiple payloads 2840 which may be pushed on or off with a motor.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Certain embodiments of hub 300 can comprise two arms 302. In certain such embodiments the two arms 302 can be on the same side, so as to remove the spent battery, and then move out the way so the second arm waiting with a full battery can insert the new battery. In other such embodiments, a “pass through swap” can be performed where one arm is on one side of the drone 310 and the other is on the other side. One of the arms carries the new battery - and on the 180 degree other side - the other arm stands ready to catch the “used” battery. By the first arm pushing the new battery into bay 312, the used battery is unlocked and pushed into the waiting tray/arm on the other side, and the 1st battery is locked into the drone. This can also be achieved with one arm, where an integrated “catching” bay slides under the drone to receive the spent battery.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B’s, multiple A’s and one B, or multiple A’s and multiple B’s.

What is claimed is:

1. A robotic arm configured to enable transfer of material to and from a drone, the robotic arm comprising:
a central body portion;
one or more arm sections configured to rotate with respect to the central body portion;
one or more end effectors attached to respective end portions of the one or more arm sections; and
one or more unlocking mechanisms configured to engage with a locking mechanism of the drone, a housing of the material, or both.

2. The robotic arm of claim 1, wherein the material comprises at least one or more payloads, and wherein the robotic arm further comprises at least one mechanism configured to remove the one or more payloads from the drone.

3. The robotic arm of claim 2, wherein at least one of the one or more payloads comprises a battery, and wherein the robotic arm is further configured to load the battery into a battery charging station.

4. The robotic arm of claim 2, wherein each of the one or more sections of the robotic arm is configured to hold two of the one or more payloads at the same time.

5. The robotic arm of claim 1, wherein each of the one or more sections of the robotic arm includes at least one sliding mechanism.

6. The robotic arm of claim 1, wherein each of the one or more sections of the robotic arm includes two sliding mechanisms on opposite sides of each other.

7. The robotic arm of claim 5, wherein the at least one sliding mechanism comprises a sliding motor configured to move a conduit to and from the drone, wherein the conduit is configured to transfer a liquid, a gas, or both.

8. The robotic arm of claim 7, wherein the sliding motor is coupled to at least one of the one or more unlocking mechanisms, such that the at least one of the one or more unlocking mechanisms moves with the conduit.

9. The robotic arm of claim 1, wherein the material comprises a gas or a liquid, wherein the locking mechanism includes an opening in a compartment of the drone, and wherein the robotic arm further comprises a conduit connected to a storage tank holding the gas or liquid.

10. The robotic arm of claim 9, wherein the locking mechanism comprises a valve of the compartment, and wherein the valve is a push-to-connect and push-to-disconnect mechanism.

11. The robotic arm of claim 10, further comprising a motor configured to engage the opening in order to release the conduit from the compartment.

12. The robotic arm of claim 9, wherein the gas or liquid comprises at least one of: a fertilizer, a pesticide, water, or fuel.

13. The robotic arm of claim 1, wherein at least one of the one or more arm sections includes a battery swapping mechanism and at least another of the one or more arm sections includes a refilling mechanism.

14. The robotic arm of claim 1, wherein the one or more arm sections are two or more arm sections, wherein the two or more arm sections are oriented 90 degrees with respect to each other.

15. The robotic arm of claim 1, wherein the one or more arm sections are two arm sections oriented 180 degrees with respect to each other.

16. The robotic arm of claim 1, wherein the one or more arm sections are three arm sections located within a single plane and oriented 120 degrees with respect to one another.

17. The robotic arm of claim 1, wherein the robotic arm is a 3-axis cartesian robotic arm with one axis being rotary.

18. The robotic arm of claim 1, wherein the robotic arm is configured to use the unlocking mechanism to rotate a locking mechanism on the drone.

19. The robotic arm of claim 1, wherein the robotic arm further comprises a mating mechanism configured to hold the robotic arm to the drone.

20. The robotic arm of claim 19, wherein the mating mechanism comprises two or more grippers configured to grip onto indentations in the drone, wherein the grippers help to align the robotic arm to the drone.

21. The robotic arm of claim 19, wherein the mating mechanism comprises at least a positive and negative connection from the robotic arm to the drone.

22. A robotic arm configured to enable a transfer of material in and out of a vehicle, the robotic arm comprising:
a rail and pulley system;
a central body portion attached to the rail and pulley system, and configured to move along the rail;
an arm attached to and configured to move with respect to the central body portion; and
end effectors on the arm configured to facilitate the transfer of the material.

23. The robotic arm of claim 22, wherein the material comprises one or more payloads, the robotic arm further comprising at least one mechanism configured to move the one or more payloads to and from the vehicle.

24. The robotic arm of claim 23, wherein the arm comprises at least two separate portions, each comprising a sliding mechanism configured to receive and unload the one or more payloads from the vehicle.

25. The robotic arm of claim 24, wherein the two separate portions are positioned opposed one another on the robotic arm.

26. The robotic arm of claim 23, wherein the arm includes a mechanism for holding a plurality of the one or more payloads, wherein the mechanism is configured to release individual ones of the plurality of the one or more payloads.

27. The robotic arm of claim 23, wherein the at least one mechanism comprises at least one sliding mechanism coupled to an unlocking mechanism, wherein the unlocking mechanism is configured to (i) in a first position, engage a locking mechanism on the vehicle and (ii) in a second position and in conjunction with the sliding mechanism, cause the one or more payloads to be moved to and from the vehicle.

28. The robotic arm of claim 22, wherein the arm comprises a first portion, a second portion, and a third portion, wherein the first and second portions of the arm are each configured to enable transfer of the material and wherein the third portion is configured to grip onto the vehicle.

29. The robotic arm of claim 28, wherein the first and second portions each comprise an unlocking mechanism configured to engage with a locking mechanism of the vehicle, of a housing of the material, or both.

30. The robotic arm of claim 28, wherein the first, second, and third portions of the arm are configured to be used both in combination and independently from one another to carry out one or more tasks.

31. The robotic arm of claim 28, wherein the first, second, and third portions comprise top, bottom, and middle portions, respectively.

32. The robotic arm of claim 22, wherein the arm includes a first section and a second section, wherein the first section is configured to grip onto the vehicle and the second section is configured to transfer the material while the first section is gripping onto the vehicle.

33. The robotic arm of claim 32, wherein the first section is configured to slide and rotate with respect to the second section.

34. The robotic arm of claim 22, wherein the material comprises a gas or a liquid, wherein the robotic arm further comprises at least one mechanism configured to engage with an opening of a compartment of the vehicle.

35. The robotic arm of claim 22, wherein the arm is configured to rotate with respect to the central body portion.

36. The robotic arm of claim 22, wherein the arm is configured to move up and down with respect to the central body portion.

37. A robotic arm configured to service a drone, the robotic arm comprising:
a central body portion;
one or more arm sections configured to move with respect to the central body portion;
one or more end effectors attached to respective end portions of the one or more arm sections; and
one or more unlocking mechanisms configured to engage with the drone.

38. The robotic arm of claim 37, the one or more end effectors comprises at least a mating mechanism configured to engage a port of: the drone, a payload of the drone, or both.

39. The robotic arm of claim 38, wherein the mating mechanism is an electrical connector configured to charge the drone, the payload, or both, and wherein the mating mechanism includes at least one positive contact and at least one negative contact.

40. The robotic arm of claim 38, wherein the mating mechanism is a connector configured for both power and data transfer.

41. The robotic arm of claim 40, wherein the connector comprises an electrical connection, an optical connection, or both.

42. The robotic arm of claim 37, further comprising at least one mechanism configured to remove one or more payloads from the drone.

43. The robotic arm of claim 37, wherein the one or more arm sections are configured to perform a plurality of drone services, wherein the plurality of drone services comprises at least (i) removing one or more batteries from the drone, (ii) installing one or more charged batteries in the drone, (iii) charging the drone, or (iv) transferring a gas or liquid into a compartment of the drone.

44. The robotic arm of claim 43, wherein at least some of the one or more arm sections are configured to perform different ones of the plurality of drone services.

45. The robotic arm of claim 43, wherein at least one of the one or more arm sections is configured to perform multiple ones of the plurality of drone services.
